(19) United States
(12) Patent Application Publication
(10) Pub. No.: US 2026/0164354 A1
(43) Pub. Date: Jun. 11, 2026

(54) RESOURCE CONFIGURATION FOR UPLINK WAKE-UP SIGNALS

(71) Applicant: Lenovo (United States) Inc., Morrisville, NC (US)

(72) Inventors: Karthikeyan Ganesan, Kronberg Im Taunus (DE); Ravi Kuchibhotla, Chicago, IL (US)

(73) Assignee: Lenovo (United States) Inc., Morrisville, NC (US)

(21) Appl. No.: 18/972,213

(22) Filed: Dec. 6, 2024

(51) Int. Cl. H04W 52/02; H04W 52/14; H04W 56/00

(52) U.S. Cl. CPC H04W 52/0235; H04W 52/146; H04W 56/004

(57) ABSTRACT

Various aspects of the present disclosure relate to a resource configuration for uplink wake-up signals (WUSs). An apparatus, such as a user equipment (UE), performs an initial cell search of one or more cells of a carrier. The UE may be configured with a resource configuration for one or more uplink resources associated with transmitting an uplink WUS. An uplink resource of the one or more uplink resources may include a common frequency resource associated with the one or more cells. The UE may transmit an uplink WUS via the common frequency resource based on the resource configuration, where the uplink WUS is configured to wake up an apparatus, such as a network equipment (NE), from a dormant state. After waking up based on receiving the uplink WUS, the NE may transmit one or more common channel signals, such as a synchronization signal block (SSB), to the UE.

### TECHNICAL FIELD

The present disclosure relates to wireless communications, and more specifically to resource configurations for uplink wake-up signals (WUSs).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to perform an initial cell search of one or more cells of a carrier, where the UE is configured with a resource configuration for one or more uplink resources, and where an uplink resource of the one or more uplink resources includes a common frequency resource associated with the one or more cells; and transmit an uplink WUS via the common frequency resource based on the resource configuration, where the uplink WUS is configured to wake up an NE from a dormant state.

A processor (e.g., a standalone processor chipset, or a component of a UE) for wireless communication is described. The processor may be configured to, capable of, or operable to perform one or more operations as described herein. For example, the processor may be configured to, capable of, or operable to perform an initial cell search of one or more cells of a carrier, where the UE is configured with a resource configuration for one or more uplink resources, and where an uplink resource of the one or more uplink resources includes a common frequency resource associated with the one or more cells; and transmit an uplink WUS via the common frequency resource based on the resource configuration, where the uplink WUS is configured to wake up an NE from a dormant state.

A method performed or performable by a UE for wireless communication is described. The method may include performing an initial cell search of one or more cells of a carrier, where the UE is configured with a resource configuration for one or more uplink resources, and where an uplink resource of the one or more uplink resources includes a common frequency resource associated with the one or more cells; and transmitting an uplink WUS via the common frequency resource based on the resource configuration, where the uplink WUS is configured to wake up an NE from a dormant state.

In some implementations of the UE, the processor, and the method described herein, the UE may be configured to, capable of, or operable to receive one or more common channel signals from the NE associated with the one or more cells based on the uplink WUS waking up the NE.

In some implementations of the UE, the processor, and the method described herein, the UE may be configured to, capable of, or operable to transmit the uplink WUS based on an absence of a synchronization signal reception during the initial cell search.

In some implementations of the UE, the processor, and the method described herein, the UE may be configured to, capable of, or operable to initiate a synchronization wait duration timer based on the resource configuration; and perform the initial cell search of the one or more cells at a candidate frequency location based on the synchronization wait duration timer.

In some implementations of the UE, the processor, and the method described herein, the UE may be configured to, capable of, or operable to transmit the uplink WUS via the common frequency resource based on an absence of a synchronization signal reception during the initial cell search and prior to expiration of the synchronization wait duration timer.

In some implementations of the UE, the processor, and the method described herein, the UE may be configured to, capable of, or operable to initiate a synchronization prohibit timer based on transmitting the uplink WUS and the resource configuration; and transmit a second uplink WUS via the common frequency resource during the synchronization prohibit timer.

In some implementations of the UE, the processor, and the method described herein, the UE may be configured to, capable of, or operable to receive a synchronization signal at the candidate frequency location prior to expiration of the synchronization wait duration timer; and stop the synchronization wait duration timer based on receiving the synchronization signal.

In some implementations of the UE, the processor, and the method described herein, the uplink WUS is a request for an on-demand common channel transmission or a semi-persistent common channel transmission from the NE, and where the NE is associated with a non-dormant cell.

In some implementations of the UE, the processor, and the method described herein, the one or more uplink resources are each configured within the carrier separately for different synchronization signal blocks (SSBs) or different SSB groups.

In some implementations of the UE, the processor, and the method described herein, the one or more uplink resources are each associated with an SSB group and configured for transmission of the uplink WUS with frequency resource hopping.

In some implementations of the UE, the processor, and the method described herein, the one or more uplink resources are configured within an uplink carrier or an uplink bandwidth part (BWP).

In some implementations of the UE, the processor, and the method described herein, the one or more uplink resources includes a common resource associated with one or more time division duplex (TDD) carriers.

In some implementations of the UE, the processor, and the method described herein, the UE is configured with the resource configuration by a home-public land mobile network (H-PLMN) during a registration process.

An NE (e.g., a base station) for wireless communication is described. The NE may be configured to, capable of, or operable to perform one or more operations as described herein. For example, the NE may be configured to, capable of, or operable to receive an uplink WUS via a common frequency resource based on a resource configuration for one or more uplink resources, where an uplink resource of the one or more uplink resources includes the common frequency resource associated with one or more cells corresponding to the NE, and where the uplink WUS is configured to wake up the NE from a dormant mode; and transmit one or more common channel signals based on the uplink WUS waking up the NE.

A processor (e.g., a standalone processor chipset, or a component of an NE) for wireless communication is described. The processor may be configured to, capable of, or operable to perform one or more operations as described herein. For example, the processor may be configured to, capable of, or operable to receive an uplink WUS via a common frequency resource based on a resource configuration for one or more uplink resources, where an uplink resource of the one or more uplink resources includes the common frequency resource associated with one or more cells corresponding to the NE, and where the uplink WUS is configured to wake up the NE from a dormant mode; and transmit one or more common channel signals based on the uplink WUS waking up the NE.

A method performed or performable by an NE (e.g., a base station) for wireless communication is described. The method may include receiving an uplink WUS via a common frequency resource based on a resource configuration for one or more uplink resources, where an uplink resource of the one or more uplink resources includes the common frequency resource associated with one or more cells corresponding to the NE, and where the uplink WUS is configured to wake up the NE from a dormant mode; and transmitting one or more common channel signals based on the uplink WUS waking up the NE.

In some implementations of the NE, the processor, and the method described herein, the NE may be configured to, capable of, or operable to receive the uplink WUS based on an absence of a synchronization signal transmission during an initial cell search of the one or more cells of a carrier associated with the NE.

In some implementations of the NE, the processor, and the method described herein, the NE may be configured to, capable of, or operable to receive the uplink WUS via the common frequency resource based on an absence of a synchronization signal transmission during an initial cell search of the one or more cells of a carrier associated with the NE and prior to expiration of a synchronization wait duration timer.

In some implementations of the NE, the processor, and the method described herein, the NE may be configured to, capable of, or operable to receive a second uplink WUS via the common frequency resource during a synchronization prohibit timer that is based on the uplink WUS and the resource configuration.

In some implementations of the NE, the processor, and the method described herein, the NE may be configured to, capable of, or operable to transmit the one or more synchronization signal at a candidate frequency location prior to the expiration of the synchronization wait duration timer

### BRIEF DESCRIPTION OF THE DRAWINGS

FIG. 1 illustrates an example of a wireless communications system in accordance with aspects of the present disclosure.

FIGS. 2 through 4 illustrate examples of flow diagrams in accordance with aspects of the present disclosure.

FIGS. 5 through 9 illustrate examples of resource configurations in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method performed by a UE in accordance with aspects of the present disclosure.

FIG. 14 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In some examples, an NE may schedule communications over the one or more of the time-frequency resources via control signaling. For example, the NE may transmit signaling to the UE indicating one or more time periods during which a transmission may arrive, referred to as monitoring occasions. The NE may indicate a periodicity of the monitoring occasions, a starting time period of the monitoring occasions, an ending time period of the monitoring occasions, and/or a duration of the monitoring occasions, among other parameters defining the monitoring occasions.

In some examples, a UE may operate with different power consumption levels in multiple power consumption modes, such as in an active mode with relatively high power consumption and an idle or inactive mode with a relatively low power consumption. A UE in a low power mode (e.g., the idle and/or inactive mode, a dormant mode) may operate using reduced transmission and/or reception capabilities (due to reduced transmit power, energy efficient radio transceivers, low power processors, etc.), may perform energy harvesting techniques to supplement battery power, may utilize sleep modes for different components of the UE, or the like. Examples of UEs that are operable in low power modes include, but are not limited to, internet of things (IoT) devices, wearable devices, remote sensor devices, and mobile devices. In some examples, a wireless device (e.g., a UE) may include multiple radios, such as a radio that operates using a relatively low power consumption level, referred to as a low power radio, and a radio that operates at a relatively high power consumption level, referred to as a main radio.

Similarly, an NE or a cell may operate with different power consumption levels in multiple power consumption modes, such as in an active mode with relatively high power consumption and an idle or inactive mode with a relatively low power consumption. An NE in a low power mode (e.g., the idle and/or inactive mode, a dormant mode) may operate using reduced transmission and/or reception capabilities (due to reduced transmit power, energy efficient radio transceivers, low power processors, etc.). In some implementations, network energy savings for 5G-A and 6G wireless communications may rely on on-demand or semi-persistent transmission of common channels or signals (e.g., SSB, master information block (MIB), system information block 1 (SIB1), paging signals) to idle mode UEs performing initial cell search or idle mode serving cell measurements. For example, the NE may save power by refraining to transmit any periodic common signals, and instead, transmitting only when a UE performs an initial cell search. Additionally, a dormant NE or cell must wake up to transmit on-demand common channels or signals to the idle mode UEs performing the initial cell search.

Aspects of the present disclosure are described in the context of a wireless communications system, and include implementations that provide for an uplink wake up signal configuration for an idle mode UE performing an initial cell search, which may enable the UE to trigger an NE to transmit common control signaling (e.g., channels including SSB, MIB, SIB1, paging signals, also referred to herein as synchronization signaling) to the idle mode UEs. In some implementations, the uplink WUS may be used to trigger a dormant NE (e.g., an NE in an idle or sleep mode) to wake up and transmit either periodic or on-demand common control signaling for the idle mode UEs.

Specifically, a UE may perform an initial cell search of one or more cells of a carrier. The UE may be configured with a resource configuration for one or more uplink resources, where an uplink resource may include a common frequency resource within a frequency band that is associated with the one or more cells. The UE may transmit an uplink WUS via the common frequency resource based on the resource configuration. In some examples, the UE may transmit the uplink WUS based on failing to receive a synchronization signal (e.g., common control signal) from the NE during the initial cell search or according to a timer. An NE may receive the uplink WUS via the common frequency resource, which may trigger the NE to wake up from a dormant mode. Once the NE is in an active (e.g., awake) mode, the NE may transmit a synchronization signal (e.g., SSB) to the UE.

By performing the described techniques, a device in a wireless communications system can improve resource utilization efficiency. For example, an NE may save power by remaining in a dormant mode until the NE receives an uplink WUS from the UE. In addition, this may improve resource efficiency by enabling the NE to transmit synchronization signals only when the UE performs an initial cell search and based on an uplink WUS (e.g., instead of periodically). The described techniques may also improve latency by triggering signaling between the UE and the NE based on an uplink resource configuration configured for the UE.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth. Aspects of the present disclosure are described in the context of a wireless communications system.

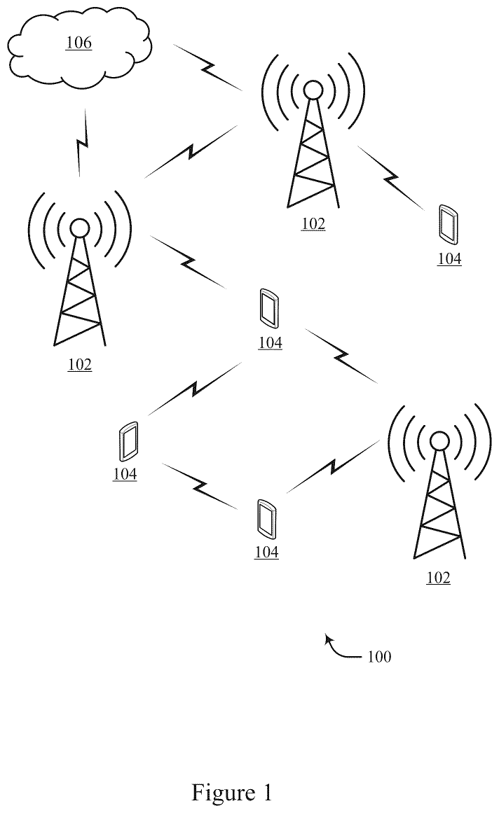

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) and a cyclic prefix. A first numerology (e.g., μ=0) may be associated with a first SCS (e.g., 15 kHz) and a normal cyclic prefix. In some implementations, the first numerology (e.g., μ=0) associated with the first SCS (e.g., 15 kHz) may utilize one slot per subframe. A second numerology (e.g., μ=1) may be associated with a second SCS (e.g., 30 kHz) and a normal cyclic prefix. A third numerology (e.g., μ=2) may be associated with a third SCS (e.g., 60 kHz) and a normal cyclic prefix or an extended cyclic prefix. A fourth numerology (e.g., μ=3) may be associated with a fourth SCS (e.g., 120 kHz) and a normal cyclic prefix. A fifth numerology (e.g., μ=4) may be associated with a fifth SCS (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2,μ=3, μ=4) associated with respective SCSs of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

In some cases, a cell may refer to a radio access node in communication with a base station or including a base station. A cell may have a coverage area, which is a geographic area in which the cell may provide wireless connectivity to devices within. Different cells may operate on defined frequencies or frequency bands, referred to as subcarriers. In some examples, a UE 104 may establish a wireless connection with a cell, and subsequently that cell may be referred to as a serving cell of the UE 104.

In some examples, the wireless communications system 100 may include one or more wireless devices (e.g., UEs 104) that may be configured to operate in multiple power consumption modes. For example, a UE 104 may operate with reduced processing, power, and/or memory capabilities when in a low power mode, including an idle and/or inactive mode. In some examples, a wireless device may perform energy harvesting techniques to collect and store energy from a received signal to supplement battery power, may use sleep modes for different components (transmitter, receiver, processing components etc.) of the wireless device, or the like. Examples wireless devices that may operate in different power consumption modes include, but are not limited to, power sensitive and/or small form factor devices, such as industrial sensors, controllers, wearable device extended reality (XR) devices (e.g., smart glasses), and mobile devices.

The IoT devices may include ambient IoT devices. There may be multiple different types of ambient IoT devices. A first type of ambient IoT device, referred to as a passive IoT device, may have no energy storage and no independent signal generation, thus may use backscattering transmission techniques to communicate signaling. A second type of ambient IoT device, referred to as a semi-passive IoT device, may have energy storage, but may not perform independent signal generation. Semi-passive IoT devices may use backscattering transmission techniques and may use stored energy to amplify the reflected (e.g., backscattered) signals. A third type of ambient IoT device, referred to as an active IoT device, may have energy storage and independent signal generation. For example, an active IoT device may include active radio frequency (RF) components (e.g., radio, receiver, transmitter, transceiver) for transmitting and/or receiving signals.

In some examples, an NE 102 may transmit a WUS to a low power radio to indicate for the UE 104 to wake up, or activate, a main radio to transmit or receive signaling. For example, the NE 102 may transmit a WUS to the UE 104 prior to a random-access channel (RACH) procedure or prior to transmitting paging information. The low power radio may receive the WUS and may indicate for the UE 104 to activate the main radio and/or may otherwise trigger activation of the main radio. Once active, the main radio may transmit and/or receive signaling related to the RACH procedure and/or the paging information. Alternatively, a UE 104 may transmit an uplink WUS to an NE 102 in a dormant mode to indicate for the NE 102 to wake up, or activate, to transmit or receive signaling. For example, as described herein, the UE 104 may transmit an uplink WUS to the NE 102 based on performing an initial cell search.

According to implementations, one or more of the NEs 102 and the UEs 104 are operable to implement various aspects of the techniques described with reference to the present disclosure. For example, a UE 104 may perform an initial cell search of one or more cells of a carrier. The UE 104 may be configured with a resource configuration for one or more uplink resources, where an uplink resource may include a common frequency resource within a frequency band that is associated with the one or more cells. The UE 104 may transmit an uplink WUS via the common frequency resource based on the resource configuration. In some examples, the UE 104 may transmit the uplink WUS based on failing to receive a synchronization signal (e.g., common control signal) from the NE during the initial cell search or according to a timer.

An NE 102 (e.g., a base station, gNB) may receive the uplink WUS via the common frequency resource, which may trigger the NE 102 to wake up from a dormant mode. Once the NE 102 is in an active (e.g., awake) mode, the NE 102 may transmit a synchronization signal (e.g., SSB) to the UE 104.

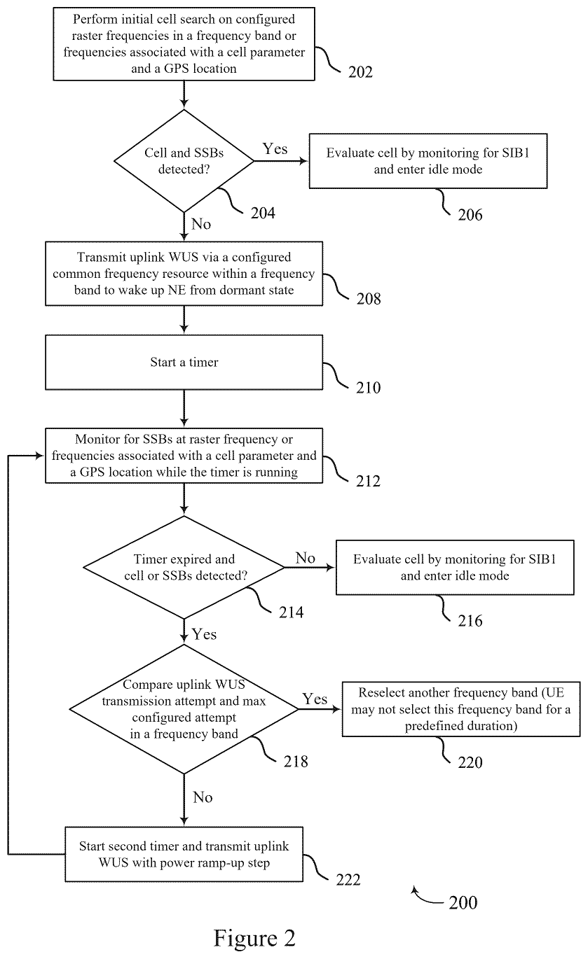

FIG. 2 illustrates an example flow diagram 200 in accordance with aspects of the present disclosure. The flow diagram 200 may illustrate a process performed by a UE for transmitting uplink WUSs to an NE according to a resource configuration. In some examples, the steps included in the flow diagram 200 may be performed in a different or by a different device or apparatus. Additionally, or alternatively, the flow diagram 200 may include additional steps or exclude one or more of the steps described herein.

At 202, a UE may perform an initial cell search for configured raster frequencies in a frequency band or stored for frequencies associated with a stored cell parameter and a global positioning system (GPS) location of the UE. The UE may be configured (i.e., preconfigured) with a set of parameters by an H-PLMN during registration or by a U-SIM. The set of parameters may be referred to herein as a resource configuration. In some examples, the parameters may be updated during subsequent registrations to the H-PLMN or using a system information broadcast message (e.g., an SIB1). While the UE is performing the initial cell search, the cell (referred to herein as an NE) may be in a dormant state, meaning that the NE may refrain from transmitting common channel signals (e.g., SSB, MIB, SIB1 signals).

In some implementations, instead of performing the initial cell search for an entire frequency raster within a frequency band, the UE may perform the search for a cell frequency already stored in the universal subscriber identity module (U-SIM) or for one or more cell frequencies configured via the H-PLMN (e.g., included in the set of parameters). In some examples, the UE may perform the search for other frequencies or frequency ranges.

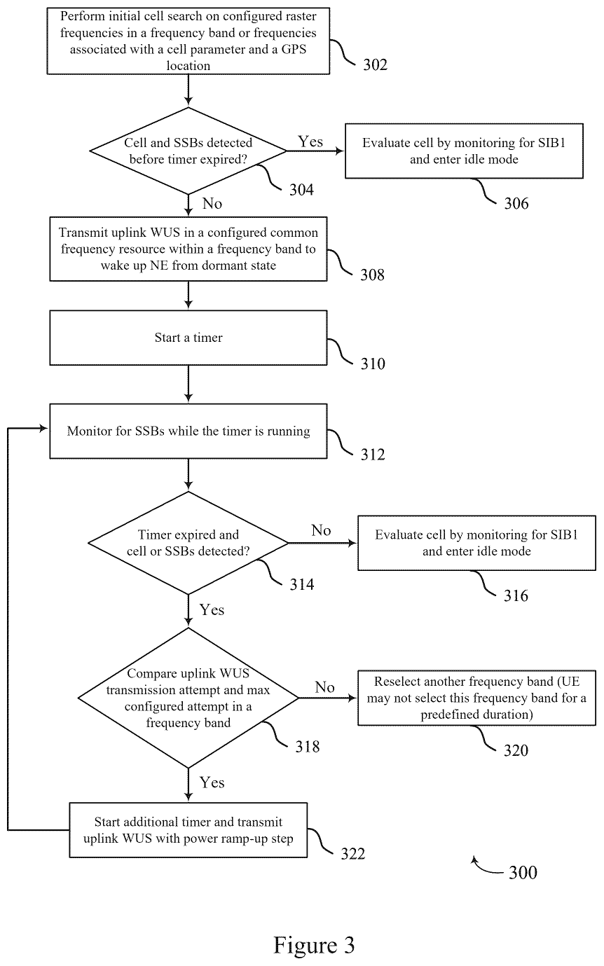

When performing the initial cell search, the UE may not know a starting frequency location of a carrier within a frequency band, and so may scan an entire raster frequency of a frequency band for candidate synchronization signals. The NE may transmit the candidate synchronization signals within a carrier according to a default time periodicity (i.e., 20 ms, 40 ms). The default time periodicity may be configured based on at least one of a frequency range (e.g., until 1 GHz, from 1 GHz to 3 GHz, from 3 GHz to 6 GHz, and so on), a bandwidth, and an SCS so that the UE may find a suitable cell. In some implementations, the UE may select a frequency band according to a previously-stored frequency band parameter (e.g., a recently camped frequency band, a preferred frequency band). Alternatively, the UE may start a timer to scan for the synchronization signals from the NE within a preconfigured time duration, as described herein with reference to FIG. 3.

In some examples, the resource configuration may include a configuration for a common frequency resource within a frequency band. The common frequency resource may be associated with one or more carrier frequencies or cells. In some implementations, the common frequency resource may be intra-frequency within a band, which means that when the UE transmits the uplink WUS, carrier frequencies or cells associated with the common frequency may wake up from a dormant state to transmit synchronization signals.

In some implementations, the common frequency resource in one frequency band may be associated with a carrier frequency or cells of, or may be intra-frequency within, another frequency band. In such scenarios, there may be multiple frequency resources for uplink WUS transmissions, where each frequency resource for an uplink WUS may be associated with one cell within a same frequency band (e.g., intra-frequency), a group of cells within a same frequency band as that of the uplink WUS, or associated to one or group of cells in a different frequency band (e.g., inter-frequency). In some examples, one or more cells may be collocated within a NE, where one cell may be configured to monitor for an uplink WUS and wake up the one or more collocated cells based on receiving the uplink WUS.

At 204, the UE may evaluate whether it has detected (or received) one or more SSBs from the NE and detected the NE itself during the initial cell search. At 206, if the UE has detected the SSBs and corresponding NE during the initial cell search, then the UE may evaluate the NE by monitoring for an SIB1 and subsequently enter an idle mode.

Alternatively, at 208, if the UE failed to detect the SSBs and corresponding NE during the initial cell search, then the UE may transmit a first uplink WUS via a configured common frequency resource within a frequency band. The first uplink WUS may wake up the NE from a dormant state and trigger the NE to transmit on-demand, semi-persistent, or periodic synchronization signals (e.g., SSBs), MIBs, SIB1s, or other signals the UE may use to perform initial access and enter an idle mode.

At 210, in some implementations, the UE may start a timer after transmitting the uplink WUS. For example, the UE may start a synchronization prohibit timer, which may be a wait duration (in ms, sec, minutes, or some other time unit) during which the UE may wait to trigger a second uplink WUS transmission after the first uplink WUS. The UE may start the synchronization prohibit timer after transmitting the first uplink WUS, and the UE may refrain from transmitting the second uplink WUS until the synchronization prohibit timer has expired. A value (e.g., time duration) of the synchronization prohibit timer may be configured as part of the resource configuration, or the value may be an integer multiple of an uplink WUS period. The synchronization prohibit timer is further described herein with reference to FIG. 3.

At 212, while the synchronization prohibit timer is running, the UE may monitor for SSBs at a raster frequency or frequencies associated with a cell parameter (e.g., configured in the resource configuration) and a GPS location of the UE.

At 214, the UE may detect (e.g., receive) one or more SSBs from the NE before expiration of the synchronization prohibit timer, or the synchronization prohibit timer may expire before the UE detects (e.g., receives) any SSBs from the NE. At 216, if the UE detected one or more SSBs prior to expiration of the synchronization prohibit timer, then the UE may evaluate the cell by monitoring for an SIB1 and subsequently, enter into an idle mode. At 218, alternatively, if the synchronization prohibit timer expires and there was an absence of SSB reception during the duration of the synchronization prohibit timer, then the UE may compare a number of uplink WUS transmission attempts it has made to a maximum configured number of uplink WUS transmission attempts in a given frequency band. That is, a maximum number of allowed uplink WUS transmissions (e.g., a number of uplink WUS the UE is allowed to attempt) may be pre-configured (e.g., in the resource configuration).

At 220, if the number of uplink WUS transmission attempts would exceed the maximum configured value, then the UE may no longer select that cell, band, or frequency associated with the uplink WUS for a preconfigured time duration. The UE may reselect another frequency band for future uplink WUS transmissions.

At 222, if the number of uplink WUS transmission attempts is less than the maximum configured value, then the UE may begin a second timer (e.g., a second synchronization prohibit timer) and transmit a subsequent uplink WUS accordingly, including a power ramp-up step. The UE may then repeat steps 212 through 222 until it attempts the maximum configured number of uplink WUS transmission attempts.

In some examples, a UE operating in an idle mode may request the NE to transmit an on-demand MIB or SIB1 or a semi-persistent physical broadcast channel (PBCH) or SIB1. The UE may communicate the request to the UE using a similar approach to transmitting the uplink WUS. In some implementations, the NE may configure separate uplink resources for each common channel available for uplink WUS transmissions using a combination of time-frequency domain and code-domain resources. Additionally, the NE may provide information to the UE indicating which common channel (e.g., SIB1, MIB) may be configured for on-demand or semi-persistent transmission. The UE performing initial access may transmit an uplink WUS to request a common channel transmission from the NE using similar procedures as described herein.

In some implementations, the NE may enter (e.g., return to) a dormant state from an active state if the NE fails to receive a RACH request or a scheduling request from the UE, of if the NE refrains from transmitting downlink and uplink scheduling grants to the UE for a period of time. In some examples, the NE may be configured within a time window during which there may be a lack of downlink and uplink activity from the NE. The NE may explicitly signal to UEs operating in an idle mode to reselect a different NE or cell before the NE enters a dormant mode. The NE may transmit the reselection request via a paging message using radio resource control (RRC) signaling, a paging downlink control information (DCI), an early paging indication, a low-power WUS, a SIB, or any combination thereof. There may be a sufficient time period between a time when the NE transmits the reselection request to the UE and a time when the NE enters the dormant mode. In some implementations, an NE may transit low-power WUSs to wake up all UEs (in a sleep or dormant mode), such that the UEs may receive the reselection request as described herein.

FIG. 3 illustrates an example flow diagram 300 in accordance with aspects of the present disclosure. The flow diagram 300 may illustrate a process performed by a UE for transmitting uplink WUSs to an NE according to a resource configuration. In some examples, the steps included in the flow diagram 300 may be performed in a different or by a different device or apparatus. Additionally, or alternatively, the flow diagram 300 may include additional steps or exclude one or more of the steps described herein.

At 302, a UE may perform an initial cell search for configured raster frequencies in a frequency band or stored for frequencies associated with a stored cell parameter and a GPS location of the UE. The UE may be configured (i.e., preconfigured) with a set of parameters by an H-PLMN during registration or by a U-SIM. The set of parameters may be referred to herein as a resource configuration. In some examples, the parameters may be updated during subsequent registrations to the H-PLMN or using a system information broadcast message (e.g., an SIB1). While the UE is performing the initial cell search, the cell (referred to herein as an NE) may be in a dormant state, meaning that the NE may refrain from transmitting common channel signals (e.g., SSB, MIB, SIB1 signals). In some implementations, the UE may perform the initial cell search for different frequencies as described herein with reference to FIG. 2.

In some examples, the resource configuration may include configurations for timers and other parameters, such as a synchronization wait duration timer, a synchronization prohibit timer, and a maximum number of uplink WUS transmissions, among other parameters.

For example, the resource configuration may include a configuration for a synchronization wait duration timer (in milliseconds (ms), seconds, minutes, or another time unit). The synchronization wait duration timer may trigger the UE to transmit the uplink WUS. That is, the UE may perform the initial cell search toward the NE by scanning for a candidate synchronization signal at an initial raster frequency or a carrier frequency within a cell. The UE may start the synchronization wait duration timer as soon as the UE begins the initial cell search for an initial synchronization signal (e.g., a primary synchronization signal (PSS), a secondary synchronization signal (SSS)) from the NE.

At 304, the UE may evaluate whether it has detected one or more SSBs from the NE prior to expiration of the synchronization wait duration timer. The UE may continue searching for the initial synchronization signal at candidate frequency locations after starting the synchronization wait duration timer.

At 306, if the UE received an initial synchronization signal at a candidate frequency location before expiration of the synchronization wait duration timer, the UE may stop the synchronization wait duration timer, evaluate the corresponding cell by monitoring for an SIB1, and subsequently enter into an idle mode.

At 308, alternatively, if the UE fails to receive the initial synchronization signal at the candidate frequency location before expiration of the synchronization wait duration timer, then the UE may transmit a first uplink WUS to the NE upon expiration of the synchronization wait duration timer. The UE may transmit the first uplink WUS in a common frequency resource within a frequency band (e.g., configured in the resource configuration). The first uplink WUS, if received by an NE, may wake up the NE from a dormant state.

At 310, if the UE fails to receive a synchronization signal from the NE during the duration of the synchronization wait duration timer, then the UE may start a second timer. The second timer may be a synchronization prohibit timer, which may be configured in the resource configuration. The synchronization prohibit timer may be a second wait duration (in ms, seconds, minutes, or another time unit) during which the UE may wait to transmit a second uplink WUS subsequent to the first uplink WUS. That is, the UE may start the synchronization prohibit timer after transmitting the first uplink WUS, and the UE may refrain from transmitting the second uplink WUS until expiration of the synchronization prohibit timer. A value (e.g., length) of the synchronization prohibit timer may be configured with the parameters, and may depend on at least one of a frequency range, an SCS, or a multiple-input multiple-output (MIMO) capability of the NE, among other factors.

At 312, the UE may monitor for SSBs from the NE while the synchronization prohibit timer is running. At 314, the UE may detect (e.g., receive) one or more SSBs from the NE before expiration of the synchronization prohibit timer, or the synchronization prohibit timer may expire before the UE detects (e.g., receives) any SSBs from the NE. At 316, if the UE detected one or more SSBs prior to expiration of the synchronization prohibit timer, then the UE may evaluate the cell by monitoring for an SIB1 and subsequently, enter into an idle mode. At 318, alternatively, if the synchronization prohibit timer expires and there was an absence of SSB reception during the duration of the synchronization prohibit timer, then the UE may compare a number of uplink WUS transmission attempts it has made to a maximum configured number of attempts in a given frequency band. That is, a maximum number of uplink WUS transmissions (e.g., a number of uplink WUS the UE is allowed to attempt) may be pre-configured (e.g., in the resource configuration). The maximum value may be a number of uplink WUS transmissions after which the UE may not select one or more cells, bands, or frequencies associated with the uplink WUS for a configured time duration.

At 320, if the number of uplink WUS transmission attempts would exceed the maximum configured value, then the UE may no longer select that cell, band, or frequency associated with the uplink WUS for a preconfigured time duration. The UE may reselect another frequency band for future uplink WUS transmissions.

At 322, if the number of uplink WUS transmission attempts is less than the maximum configured value, then the UE may begin an additional timer (e.g., a second synchronization prohibit timer) and transmit a subsequent uplink WUS accordingly, including a power ramp-up step. That is, the UE may transmit the second uplink WUS according to the second synchronization prohibit timer if the UE fails to receive a synchronization signal from the NE during the previous synchronization prohibit timer. The UE may then repeat steps 312 through 322 until it attempts the maximum configured number of uplink WUS transmission attempts.

In some implementations, the timers (e.g., the synchronization wait duration timer and the synchronization prohibit timer) and uplink resources (e.g., a common frequency resource) may be configured or configured to the UE by an H-PLMN separately for each radio access technology (RAT) (e.g., 5G, 6G) and/or for separate frequency ranges, bands, or carriers during an initial registration step with the network, which may occur during an initial access procedure (e.g., attach accept). Additionally, the timers, uplink resources, and associated values may be updated using a system information broadcast at subsequent times (e.g., during later registrations). In some examples, a serving cell may configure the uplink resource configuration for the UE with a validity, where the validity may be configured up to X hours in the system information. After a validity timer associated with the last-received system information has expired, the UE may start using the configured uplink resource configuration from the last (e.g., most recent or prior) registration. In some implementations, one or more uplink frequency resources may be configured within a carrier bandwidth of a cell or frequency, such that an uplink WUS may be separately configured according to particular frequency ranges, carriers, and bands. Alternatively, an uplink WUS may be configured in a common frequency resource that may be common for one or more cells, bands, or frequency ranges. Multiple common frequency resources may be configured for one or more cell groups.

The uplink resource configuration may be for one RAT (e.g., 5G) for the transmission of an uplink WUS toward another RAT (e.g., 5G). In some examples, an uplink WUS may be configured to be repeatedly transmitted with different frequencies within a frequency band, using step-up ramping of transmit power, or using another preamble with more guard time. Additionally, or alternatively, a maximum number of uplink WUS transmissions may be configured to be transmitted with a same frequency resource with step-up ramping of uplink transmit power (until a maximum transmit power of the UE is reached).

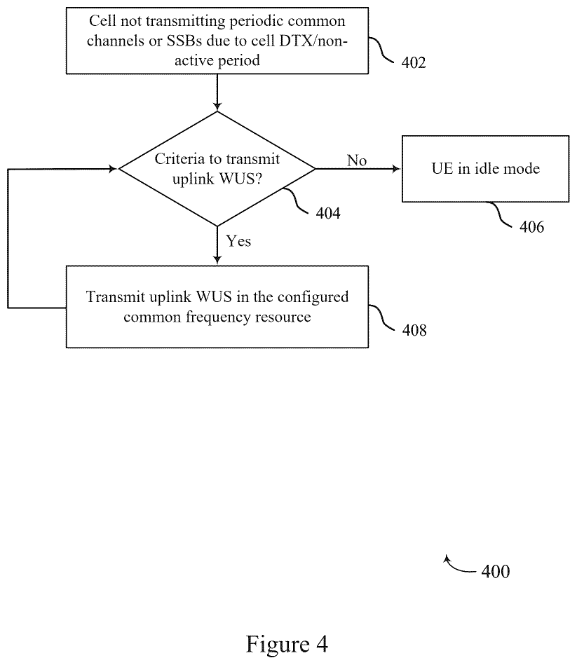

FIG. 4 illustrates an example flow diagram 400 in accordance with aspects of the present disclosure. The flow diagram 400 may illustrate a process performed by a UE for transmitting uplink WUSs to an NE according to a resource configuration. In some examples, the steps included in the flow diagram 400 may be performed in a different or by a different device or apparatus. Additionally, or alternatively, the flow diagram 400 may include additional steps or exclude one or more of the steps described herein.

In some implementations, the uplink WUS may serve as a request, from a UE in an idle mode, for on-demand or semi-persistent common channel transmissions (e.g., SSB, MIB, SIB1) from a non-dormant NE (e.g., a non-dormant cell). For example, after performing an initial cell search, a UE operating in an idle mode may monitor for a paging message to begin a network-initiated downlink transmission or a UE-originated uplink transmission.

At 402, an NE (e.g., a cell) may refrain from transmitting periodic common channels or SSBs due to a cell discontinuous transmission (DTX) period or non-active period. In such scenarios, the NE may enter into an energy saving mode by configuring a cell DTX or discontinuous reception (DRX) for the UE. That is, the NE may refrain from transmitting downlink signals (e.g., common channel signals such as SSBs, SIB1s, and paging signals), and the UE may transmit an uplink WUS if the UE fulfills some criteria or conditions using a preconfigured resource or a resource signaled in a previous SIB1 whose validity did not yet expire.

At 404, the UE may determine whether it satisfies the criteria for transmitting an uplink WUS. The criteria may include mobility of the UE, cell re-selection criteria, uplink traffic arrival at an uplink buffer, a time sync error or time drift, and other conditions. For example, the UE may meet the criteria for transmitting the uplink WUS if a mobility criteria of the UE is met (e.g., not stationary), a cell re-selection threshold criteria is met, the uplink traffic arrival at the uplink buffer is met, and the time sync error or time drift is above a particular threshold.

At 406, if the UE does not satisfy the criteria for transmitting the uplink WUS, then the UE may enter an idle mode. At 408, alternatively, if the UE satisfies the criteria, then the UE may transmit the uplink WUS to the NE in a common frequency resource (e.g., configured for the UE in a resource configuration, as described herein with reference to FIG. 2).

The uplink WUS may be configured with an offset (in ms) with respect to each candidate SSB or group of candidate SSBs or SSB burst time domain locations. That is, after transmitting the uplink WUS, the UE may start a timer to wait for the reception of SSBs, and the UE may stop the timer if it receives an SSB prior to expiration of the timer. If the UE fails to receive SSBs before the timer expires, then the UE may transmit another uplink WUS. The UE may transmit uplink WUSs until the maximum allowed number of transmissions, as configured by the H-PLMN, the U-SIM, or an SIB1. In some implementations, the UE may reselect another frequency band for transmitting uplink WUSs after the maximum number of transmissions is reached.

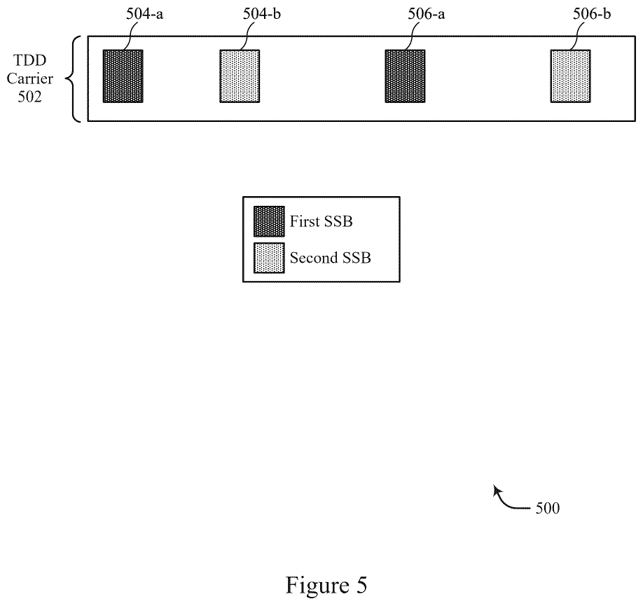

FIG. 5 illustrates an example resource configuration 500 in accordance with aspects of the present disclosure. The resource configuration 500 may be for uplink resources 504, which a UE may utilize for transmission of an uplink WUS. The UE may be configured or pre-configured with the resource configuration 500.

In the resource configuration 500, uplink WUSs and corresponding SSBs may be configured for transmission to the UE in a same bandwidth of a TDD carrier 502. That is, uplink resources 504 (frequency-code domain or time-frequency-code domain resources) may be configured within the TDD carrier 502 separately for different SSBs or SSB groups, such as a first SSB and a second SSB. The first SSB and the second SSB may each represent individual SSBs or SSB groups. For example, an uplink resource 504-a may be configured for an SSB 506-a, which may represent an SSB group. As such, when an NE receives an uplink WUS associated with the SSB group, the NE may transmit one or more on-demand or semi-persistent SSBs associated with the SSB group. Additionally, an uplink resource 504-b may be configured for an SSB 506-b. In some examples, a code-domain resource may be assigned to an SSB or SSB group using a cyclic shift.

In some examples, the uplink resource configuration may include a frequency division multiplexed (FDM) uplink resource, where uplink WUS occasions may be mapped to carrier frequencies in ascending order starting from a lowest subcarrier. An uplink WUS may be allocated in a sub-1 GHz frequency for a dormant cell operating at a sub-1 GHz, 2 GHz, or 3.5 GHz frequency.

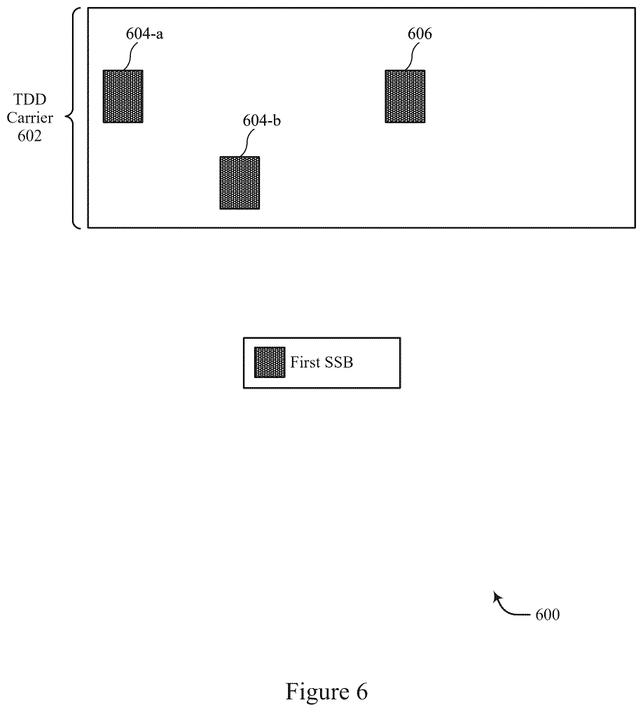

FIG. 6 illustrates an example resource configuration 600 in accordance with aspects of the present disclosure. In this example, the resource configuration 600 may be for uplink resources 604, which a UE may utilize for transmission of an uplink WUS. The UE may be configured or pre-configured with the resource configuration 600.

In the resource configuration 600, each uplink resource 604 associated with an SSB or an SSB group may be configured to be transmitted with a frequency resource hopping configuration. For example, within a TDD carrier 602, an uplink resource 604-a and an uplink resource 604-b may be configured for an SSB 606 (e.g., a first SSB), which may represent an individual SSB or an SSB group. The uplink resource 604-a and the uplink resource 604-b may be configured with frequency resource hopping, such that the UE may transmit an uplink WUS at different frequencies within the available bandwidth of the TDD carrier 602.

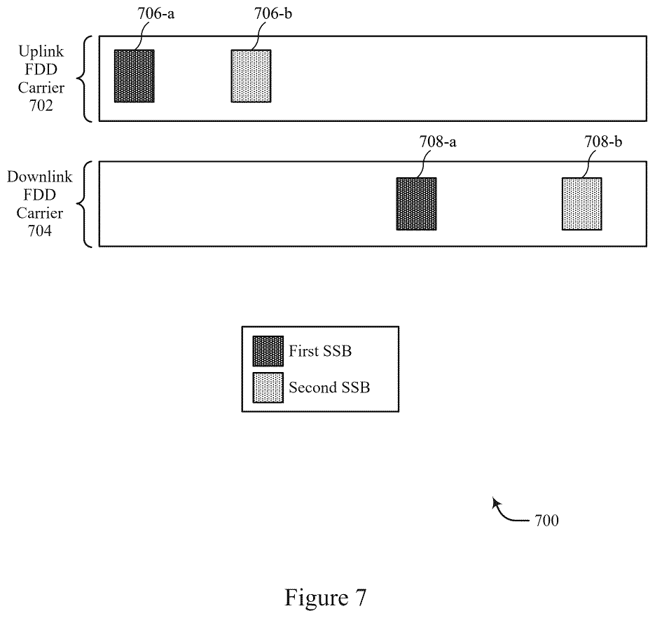

FIG. 7 illustrates an example resource configuration 700 in accordance with aspects of the present disclosure. In this example, the resource configuration 700 may be for one or more uplink resources 706, which a UE may utilize for transmission of an uplink WUS. The UE may be configured or pre-configured with the resource configuration 700.

In the resource configuration 700, one or more uplink resources 706 may be configured in a frequency division duplex (FDD) carrier, which may include an uplink FDD carrier 702 and a downlink FDD carrier 704. For example, an uplink resource 706-a may be configured for the uplink FDD carrier 702, where the uplink resource 706-a may be associated with an SSB 708-a (e.g., a first SSB) configured for the downlink FDD carrier 704. In addition, an uplink resource 706-b may be configured for the uplink FDD carrier 702, where the uplink resource 706-b may be associated with an SSB 708-b (e.g., a second SSB) configured for the downlink FDD carrier 704. The SSB 708-a and the SSB 708-b may each represent an individual SSB or an SSB group.

The uplink resource 706-a and the uplink resource 706-b may be configured within the uplink FDD carrier 702, such that an NE may switch off downlink transmissions via the downlink FDD carrier 704 or a downlink BWP and monitor for one or more uplink WUSs via the uplink FDD carrier 702 or an uplink BWP. Upon receiving an uplink WUS via the uplink resource 706-a or the uplink resource 706-b via the uplink FDD carrier 702, the NE may enable common channel transmissions, including the SSB 708-a and the SSB 708-b, in the downlink FDD carrier 704 or the downlink BWP.

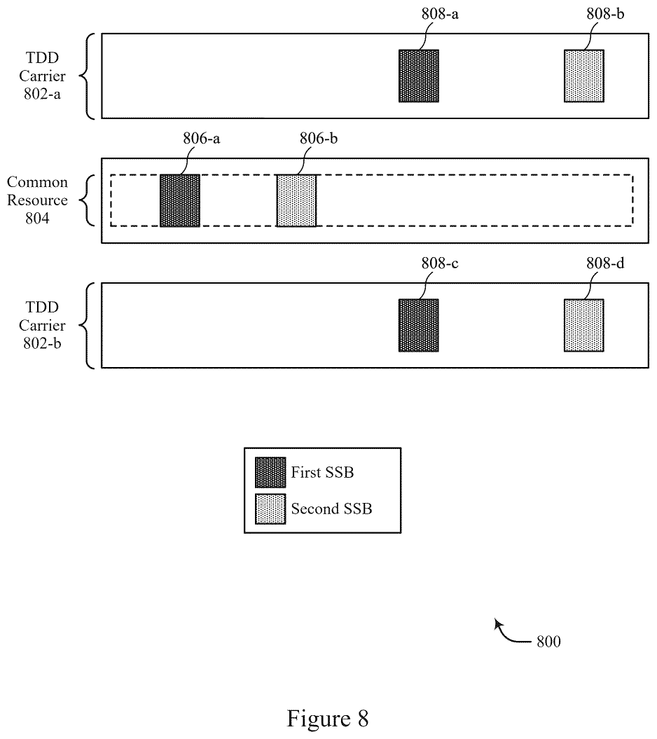

FIG. 8 illustrates an example resource configuration 800 in accordance with aspects of the present disclosure. In this example, the resource configuration 800 may be for uplink resources 806, which a UE may utilize for transmission of an uplink WUS. The UE may be configured or pre-configured with the resource configuration 800.

In the resource configuration 800, one or more uplink resources 806 may be configured in a TDD common resource 804, and the TDD common resource 804 may be associated with one or more TDD carriers, including a TDD carrier 802-a and a TDD carrier 802-b. For example, an uplink resource 806-a may be configured in the TDD common resource 804, where the uplink resource 806-a may be associated with an SSB 808-a in the TDD carrier 802-a and an SSB 808-c in the TDD carrier 802-b (e.g., first SSBs). In addition, an uplink resource 806-b may be configured in the TDD common resource 804, where the uplink resource 806-b may be associated with an SSB 808-b in the TDD carrier 802-a and an SSB 808-d in the TDD carrier 802-b (e.g., second SSBs). The SSBs 808 may each represent an individual SSB or a group of SSBs.

According to the resource configuration 800, an NE may transmit SSBs 808 from the TDD carriers 802 (e.g., the TDD carrier 802-a and the TDD carrier 802-b). The uplink resources 806 may be configured as separate code-domain resources in the TDD common resource 804 (associated with each TDD carrier 802 within a band). As such, the UE may transmit an uplink WUS via the uplink resource 806-a or the uplink resource 806-b and receive a corresponding SSB via the TDD carrier 802-a or the TDD carrier 802-b.

In some examples, the uplink resource configuration (e.g., any of the resource configuration 500, the resource configuration 600, the resource configuration 700, the resource configuration 800, or the resource configuration 900) may include a maximum repeated value of uplink WUS transmissions per carrier frequency, frequency range, or band. The UE may transmit each uplink WUS in a different carrier frequency in a band after reaching the maximum number of allowed uplink WUS transmissions in a carrier frequency. Similarly, an uplink WUS may be configured to be transmitted in different frequency ranges such as 0 GHz to 1 GHz, 1 GHz to 3 GHz, 3 GHz to 6 GHz, and so on, such that the UE may find a suitable cell. The UE's behavior may depend on the uplink resource configuration, particularly whether uplink resources for transmitting uplink WUSs are configured according to a carrier frequency in a band or in a different frequency range.

In some examples, where a UE in an idle or inactive mode may not know of a NE monitoring for an uplink WUS, the UE may be configured with an uplink WUS transmission in every preconfigured frequency raster in a frequency band. In some implementations, the UE may scramble a cell identifier (ID) when it generates an uplink WUS for transmission such that only cells or NEs that have the same cell ID as in the uplink WUS may transmit on-demand or semi-persistent common channels or signals back to the UE. The UE may determine which cell ID to include with an uplink WUS based on a common portion of the cell ID, or the UE may attempt to include multiple IDs.

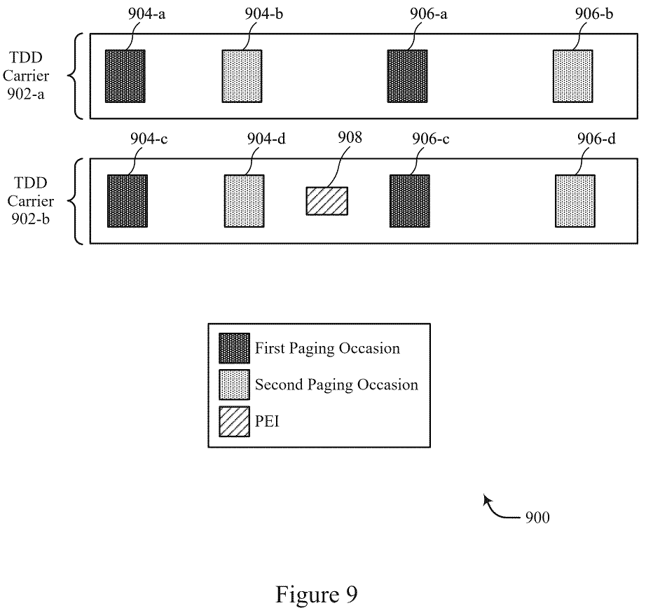

FIG. 9 illustrates an example resource configuration 900 in accordance with aspects of the present disclosure. In this example, the resource configuration 900 may be for uplink resources 904, which a UE may utilize for transmission of an uplink WUS. The UE may be configured or pre-configured with the resource configuration 900.

As described herein, a NE may not know an ID of a UE transmitting uplink WUSs to the NE, where the uplink WUSs may wake up the NE from a dormant mode and trigger the NE to transmit on-demand or semi-persistent SSBs. As such, the NE may transmit a paging message corresponding to all paging subgroups in a cell within a RAN paging area. In such scenarios, the resource configuration 900 may support separate uplink resources (e.g., combination of time, frequency, and code-domain resources) may be configured per paging sub-group ID, and the UE may select a particular uplink resource according to the corresponding sub-group ID calculated from its international mobile subscriber identity (IMSI).

In some implementations, the NE may transmit a paging message to the UE during a paging occasions 906 associated with a sub-group ID. Each paging message associated with a sub-group ID may be associated with a separate paging occasion 906. In some examples, the NE may transmit an early paging message to the UE indicating the sub-group ID corresponding to a configured uplink resource to wake up a subset of UEs belonging to the sub-group ID so that the UEs may monitor for paging DCI. Subsequently, the NE may transmit a paging message during a paging occasion 906 associated with that sub-group ID.

For example, according to the resource configuration 900, one or more uplink resources 904 may be configured in a TDD carrier 902-a or a TDD carrier 902-b. Each uplink resource 904 may be associated with a paging occasion 906. For example, in the TDD carrier 902-a, an uplink resource 904-a may be configured and associated with a paging occasion 906-a (e.g., a first paging occasion), while an uplink resource 904-b may be configured and associated with a paging occasion 906-b (e.g., a second paging occasion). In addition, in the TDD carrier 902-b, an uplink resource 904-c may be configured and associated with a paging occasion 906-c (e.g., a first paging occasion), while an uplink resource 904-d may be configured and associated with a paging occasion 906-d (e.g., a second paging occasion). In some implementations, the NE may transmit a paging early indication (PEI) 908 (e.g., an early paging message) indicating the sub-group ID to the UE such that the UE may monitor the paging occasion 906-c and the paging occasion 906-d accordingly.

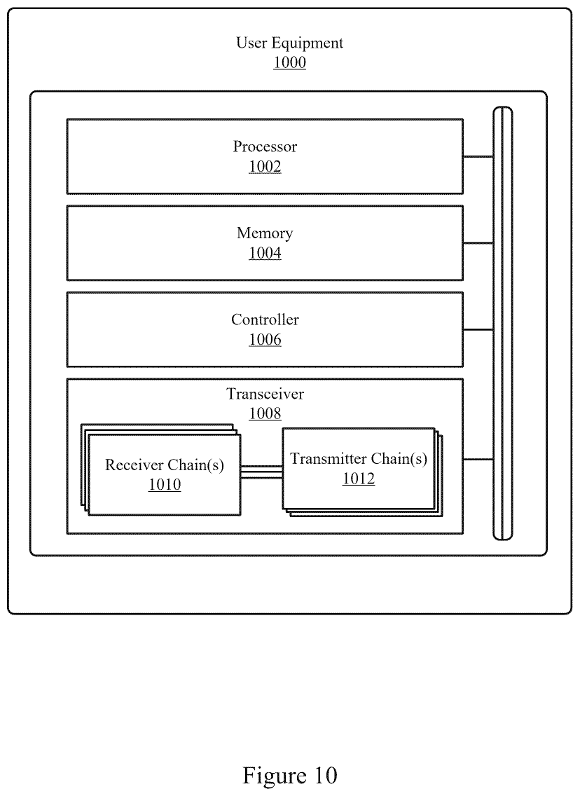

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, function ally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for performing an initial cell search of one or more cells of a carrier, where the UE is configured with a resource configuration for one or more uplink resources, and where an uplink resource of the one or more uplink resources includes a common frequency resource associated with the one or more cells; and transmitting an uplink WUS via the common frequency resource based on the resource configuration, where the uplink WUS is configured to wake up an NE from a dormant state.

Additionally, the UE 1000 may be configured to support any one or combination of receiving one or more common channel signals from the NE associated with the one or more cells based on the uplink WUS waking up the NE; transmitting the uplink WUS based on an absence of a synchronization signal reception during the initial cell search; initiating a synchronization wait duration timer based on the resource configuration, and performing the initial cell search of the one or more cells at a candidate frequency location based on the synchronization wait duration timer; transmitting the uplink WUS via the common frequency resource based on an absence of a synchronization signal reception during the initial cell search and prior to expiration of the synchronization wait duration timer; initiating a synchronization prohibit timer based on transmitting the uplink WUS and the resource configuration and transmitting a second uplink WUS via the common frequency resource during the synchronization prohibit timer; receiving a synchronization signal at the candidate frequency location prior to expiration of the synchronization wait duration timer and stopping the synchronization wait duration timer based on receiving the synchronization signal; the uplink WUS being a request for an on-demand common channel transmission or a semi-persistent common channel transmission from the NE, and where the NE is associated with a non-dormant cell; the one or more uplink resources each being configured within the carrier separately for different SSBs or different SSB group; the one or more uplink resources each being associated with an SSB group and configured for transmission of the uplink WUS with frequency resource hopping; the one or more uplink resources being configured within an uplink carrier or an uplink BWP; the one or more uplink resources includes a common resource associated with one or more TDD carriers; and the UE being configured with the resource configuration by an H-PLMN during a registration process.

Additionally, or alternatively, the UE 1000 may support at least one memory (e.g., the memory 1004) and at least one processor (e.g., the processor 1002) coupled with the at least one memory and configured to cause the UE to perform an initial cell search of one or more cells of a carrier, where the UE is configured with a resource configuration for one or more uplink resources, and where an uplink resource of the one or more uplink resources includes a common frequency resource associated with the one or more cells; and transmit an uplink WUS via the common frequency resource based on the resource configuration, where the uplink WUS is configured to wake up an NE from a dormant state.

Additionally, the UE 1000 may be configured to support any one or combination of receiving one or more common channel signals from the NE associated with the one or more cells based on the uplink WUS waking up the NE; transmitting the uplink WUS based on an absence of a synchronization signal reception during the initial cell search; initiating a synchronization wait duration timer based on the resource configuration, and performing the initial cell search of the one or more cells at a candidate frequency location based on the synchronization wait duration timer; transmitting the uplink WUS via the common frequency resource based on an absence of a synchronization signal reception during the initial cell search and prior to expiration of the synchronization wait duration timer; initiating a synchronization prohibit timer based on transmitting the uplink WUS and the resource configuration and transmitting a second uplink WUS via the common frequency resource during the synchronization prohibit timer; receiving a synchronization signal at the candidate frequency location prior to expiration of the synchronization wait duration timer and stopping the synchronization wait duration timer based on receiving the synchronization signal; the uplink WUS being a request for an on-demand common channel transmission or a semi-persistent common channel transmission from the NE, and where the NE is associated with a non-dormant cell; the one or more uplink resources each being configured within the carrier separately for different SSBs or different SSB group; the one or more uplink resources each being associated with an SSB group and configured for transmission of the uplink WUS with frequency resource hopping; the one or more uplink resources being configured within an uplink carrier or an uplink BWP; the one or more uplink resources includes a common resource associated with one or more TDD carriers; and the UE being configured with the resource configuration by an H-PLMN during a registration process.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

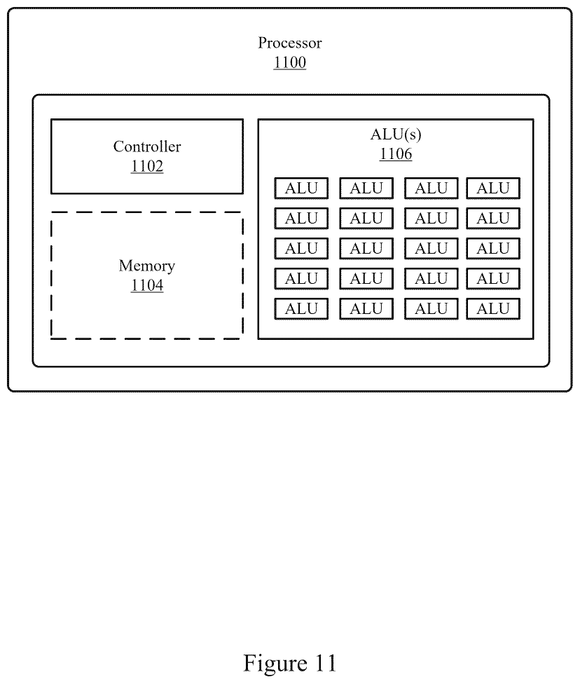

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may option ally include at least one memory 1104, which may be, for example, an L1/L2/L3 cache. Additionally, or alternatively, the processor 1100 may option ally include one or more arithmetic-logic units (ALUs) 1106. One or more of these components may be in electronic communication or otherwise coupled (e.g., operatively, communicatively, function ally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling function al units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other function al units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle condition al operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to perform an initial cell search of one or more cells of a carrier, where the UE is configured with a resource configuration for one or more uplink resources, and where an uplink resource of the one or more uplink resources includes a common frequency resource associated with the one or more cells; and transmit an uplink WUS via the common frequency resource based on the resource configuration, where the uplink WUS is configured to wake up an NE from a dormant state.

Additionally, the processor 1100 may be configured to or operable to support any one or combination of receiving one or more common channel signals from the NE associated with the one or more cells based on the uplink WUS waking up the NE; transmitting the uplink WUS based on an absence of a synchronization signal reception during the initial cell search; initiating a synchronization wait duration timer based on the resource configuration, and performing the initial cell search of the one or more cells at a candidate frequency location based on the synchronization wait duration timer; transmitting the uplink WUS via the common frequency resource based on an absence of a synchronization signal reception during the initial cell search and prior to expiration of the synchronization wait duration timer; initiating a synchronization prohibit timer based on transmitting the uplink WUS and the resource configuration and transmitting a second uplink WUS via the common frequency resource during the synchronization prohibit timer; receiving a synchronization signal at the candidate frequency location prior to expiration of the synchronization wait duration timer and stopping the synchronization wait duration timer based on receiving the synchronization signal; the uplink WUS being a request for an on-demand common channel transmission or a semi-persistent common channel transmission from the NE, and where the NE is associated with a non-dormant cell; the one or more uplink resources each being configured within the carrier separately for different SSBs or different SSB group; the one or more uplink resources each being associated with an SSB group and configured for transmission of the uplink WUS with frequency resource hopping; the one or more uplink resources being configured within an uplink carrier or an uplink BWP; the one or more uplink resources includes a common resource associated with one or more TDD carriers; and the UE being configured with the resource configuration by an H-PLMN during a registration process.

Alternatively, the processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive an uplink WUS via a common frequency resource based on a resource configuration for one or more uplink resources, where an uplink resource of the one or more uplink resources includes the common frequency resource associated with one or more cells corresponding to the NE, and where the uplink WUS is configured to wake up the NE from a dormant mode; and transmit one or more common channel signals based on the uplink WUS waking up the NE.

Additionally, the processor 1100 may be configured to or operable to support any one or combination of receiving the uplink WUS based on an absence of a synchronization signal transmission during an initial cell search of the one or more cells of a carrier associated with the NE; receiving the uplink WUS via the common frequency resource based on an absence of a synchronization signal transmission during an initial cell search of the one or more cells of a carrier associated with the NE and prior to expiration of a synchronization wait duration timer; receiving a second uplink WUS via the common frequency resource during a synchronization prohibit timer that is based on the uplink WUS and the resource configuration; and transmitting the synchronization signal at a candidate frequency location prior to the expiration of the synchronization wait duration timer.

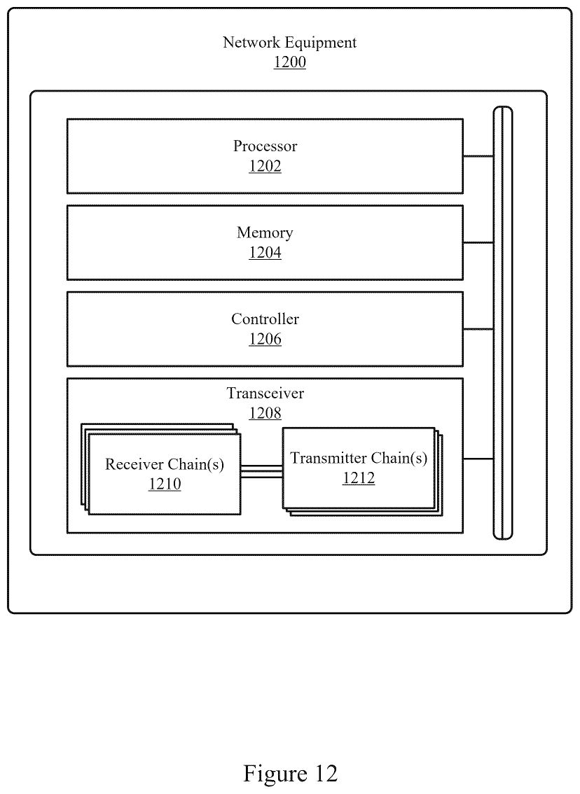

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, function ally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for receiving an uplink WUS via a common frequency resource based on a resource configuration for one or more uplink resources, where an uplink resource of the one or more uplink resources includes the common frequency resource associated with one or more cells corresponding to the NE 1200, and where the uplink WUS is configured to wake up the NE 1200 from a dormant mode; and transmitting one or more common channel signals based on the uplink WUS waking up the NE 1200.

Additionally, the NE 1200 may be configured to or operable to support any one or combination of the receiving an uplink WUS via a common frequency resource based on a resource configuration for one or more uplink resources, where an uplink resource of the one or more uplink resources includes the common frequency resource associated with one or more cells corresponding to the NE 1200, and where the uplink WUS is configured to wake up the NE 1200 from a dormant mode; and transmitting one or more common channel signals based on the uplink WUS waking up the NE 1200.

Additionally, or alternatively, the NE 1200 may support at least one memory (e.g., the memory 1204) and at least one processor (e.g., the processor 1202) coupled with the at least one memory and configured to cause the NE 1200 to receive an uplink WUS via a common frequency resource based on a resource configuration for one or more uplink resources, where an uplink resource of the one or more uplink resources includes the common frequency resource associated with one or more cells corresponding to the NE 1200, and where the uplink WUS is configured to wake up the NE 1200 from a dormant mode; and transmit one or more common channel signals based on the uplink WUS waking up the NE 1200.

Additionally, the NE 1200 may be configured to support any one or combination of receiving the uplink WUS based on an absence of a synchronization signal transmission during an initial cell search of the one or more cells of a carrier associated with the NE 1200; receiving the uplink WUS via the common frequency resource based on an absence of a synchronization signal transmission during an initial cell search of the one or more cells of a carrier associated with the NE 1200 and prior to expiration of a synchronization wait duration timer; receiving a second uplink WUS via the common frequency resource during a synchronization prohibit timer that is based on the uplink WUS and the resource configuration; and transmitting the synchronization signal at a candidate frequency location prior to the expiration of the synchronization wait duration timer.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

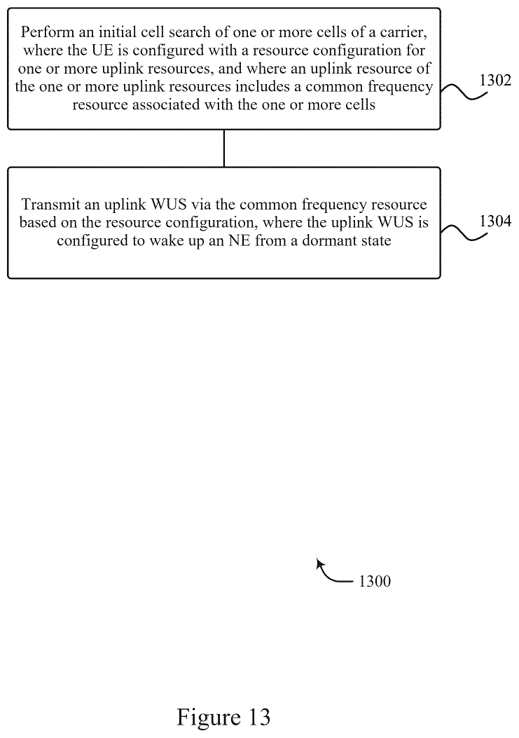

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include performing an initial cell search of one or more cells of a carrier, where the UE is configured with a resource configuration for one or more uplink resources, and where an uplink resource of the one or more uplink resources includes a common frequency resource associated with the one or more cells. The operations of 1302 may be performed in accordance with examples as described herein. In some implementations, aspects of the operations of 1302 may be performed by a UE as described with reference to FIG. 10.

At 1304, the method may include transmitting an uplink WUS via the common frequency resource based on the resource configuration, where the uplink WUS is configured to wake up an NE from a dormant state. In waking up the NE, the uplink WUS may trigger the NE to transmit one or more common channel signals (e.g., SSBs) to the UE. The operations of 1304 may be performed in accordance with examples as described herein. In some implementations, aspects of the operations of 1304 may be performed by a UE as described with reference to FIG. 10.

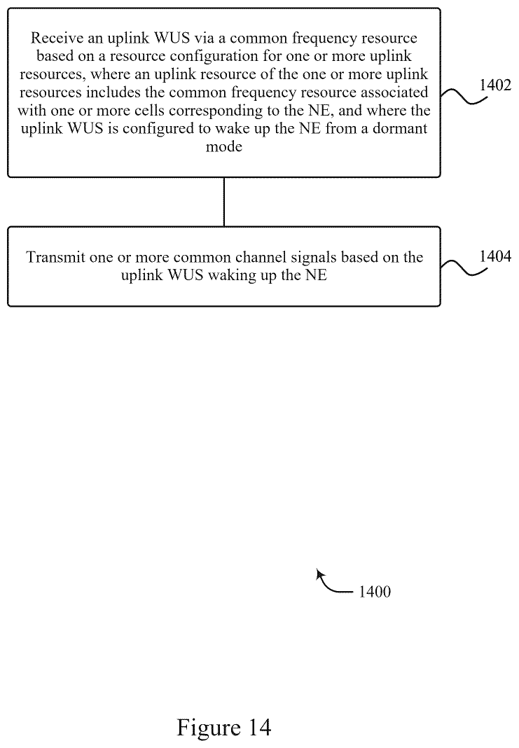

FIG. 14 illustrates a flowchart of a method 1400 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include receiving an uplink WUS via a common frequency resource based on a resource configuration for one or more uplink resources, where an uplink resource of the one or more uplink resources includes the common frequency resource associated with one or more cells corresponding to the NE, and where the uplink WUS is configured to wake up the NE from a dormant mode. The operations of 1402 may be performed in accordance with examples as described herein. In some implementations, aspects of the operations of 1402 may be performed by an NE as described with reference to FIG. 12.

At 1404, the method may include transmit one or more common channel signals (e.g., SSBs) based on the uplink WUS waking up the NE. The operations of 1404 may be performed in accordance with examples as described herein. In some implementations, aspects of the operations of 1404 may be performed by an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
perform an initial cell search of one or more cells of a carrier, wherein the UE is configured with a resource configuration for one or more uplink resources, and wherein an uplink resource of the one or more uplink resources includes a common frequency resource associated with the one or more cells; and
transmit an uplink wake-up signal (WUS) via the common frequency resource based at least in part on the resource configuration, wherein the uplink WUS is configured to wake up a network equipment (NE) from a dormant state.

2. The UE of claim 1, wherein the at least one processor is configured to cause the UE to receive one or more common channel signals from the NE associated with the one or more cells based at least in part on the uplink WUS waking up the NE.

3. The UE of claim 1, wherein to transmit the uplink WUS, the at least one processor is configured to cause the UE to transmit the uplink WUS based at least in part on an absence of a synchronization signal reception during the initial cell search.

4. The UE of claim 1, wherein the at least one processor is configured to cause the UE to:
initiate a synchronization wait duration timer based at least in part on the resource configuration, and wherein to perform the initial cell search, the at least one processor is configured to cause the UE to:
perform the initial cell search of the one or more cells at a candidate frequency location based at least in part on the synchronization wait duration timer.

5. The UE of claim 4, wherein the at least one processor is configured to cause the UE to transmit the uplink WUS via the common frequency resource based at least in part on an absence of a synchronization signal reception during the initial cell search and prior to expiration of the synchronization wait duration timer.

6. The UE of claim 5, wherein the at least one processor is configured to cause the UE to:
initiate a synchronization prohibit timer based at least in part on transmitting the uplink WUS and the resource configuration; and
transmit a second uplink WUS via the common frequency resource during the synchronization prohibit timer.

7. The UE of claim 4, wherein the at least one processor is configured to cause the UE to:
receive a synchronization signal at the candidate frequency location prior to expiration of the synchronization wait duration timer; and
stop the synchronization wait duration timer based at least in part on receiving the synchronization signal.

8. The UE of claim 1, wherein the uplink WUS is a request for an on-demand common channel transmission or a semi-persistent common channel transmission from the NE, and wherein the NE is associated with a non-dormant cell.

9. The UE of claim 1, wherein the one or more uplink resources are each configured within the carrier separately for different synchronization signal blocks (SSBs) or different SSB groups.

10. The UE of claim 1, wherein the one or more uplink resources are each associated with a synchronization signal block (SSB) group and configured for transmission of the uplink WUS with frequency resource hopping.

11. The UE of claim 1, wherein the one or more uplink resources are configured within an uplink carrier or an uplink bandwidth part (BWP).

12. The UE of claim 1, wherein the one or more uplink resources includes a common resource associated with one or more time division duplex (TDD) carriers.

13. The UE of claim 1, wherein the UE is configured with the resource configuration by a home-public land mobile network (H-PLMN) during a registration process.

14. A processor for wireless communication, comprising:
at least one controller coupled with at least one memory and configured to cause the processor to:
perform an initial cell search of one or more cells of a carrier, wherein the processor is configured with a resource configuration for one or more uplink resources, and wherein an uplink resource includes of the one or more uplink resources a common frequency resource associated with the one or more cells; and
transmit an uplink wake-up signal (WUS) via the common frequency resource based at least in part on the resource configuration, wherein the uplink WUS is configured to wake up a network equipment (NE) from a dormant state.

15. A method performed by a user equipment (UE), the method comprising:
performing an initial cell search of one or more cells of a carrier, wherein the UE is configured with a resource configuration for one or more uplink resources, and wherein an uplink resource of the one or more uplink resources includes a common frequency resource associated with the one or more cells; and
transmitting an uplink wake-up signal (WUS) via the common frequency resource based at least in part on the resource configuration, wherein the uplink WUS is configured to wake up a network equipment (NE) from a dormant state.

16. A network equipment (NE) for wireless communication, comprising:
at least one memory; and
at least one processor coupled with the at least one memory and configured to cause the NE to:
receive an uplink wake-up signal (WUS) via a common frequency resource based at least in part on a resource configuration for one or more uplink resources, wherein an uplink resource of the one or more uplink resources includes the common frequency resource associated with one or more cells corresponding to the NE, and wherein the uplink WUS is configured to wake up the NE from a dormant mode; and
transmit one or more common channel signals based at least in part on the uplink WUS waking up the NE.

17. The NE of claim 16, wherein, to receive the uplink WUS, the at least one processor is configured to cause the NE to receive the uplink WUS based at least in part on an absence of a synchronization signal transmission during an initial cell search of the one or more cells of a carrier associated with the NE.

18. The NE of claim 16, wherein, to receive the WUS, the at least one processor is configured to cause the NE to receive the uplink WUS via the common frequency resource based at least in part on an absence of a synchronization signal transmission during an initial cell search of the one or more cells of a carrier associated with the NE and prior to expiration of a synchronization wait duration timer.

19. The NE of claim 18, wherein the at least one processor is configured to cause the NE to receive a second uplink WUS via the common frequency resource during a synchronization prohibit timer that is based at least in part on the uplink WUS and the resource configuration.

20. The NE of claim 18, wherein the at least one processor is configured to cause the NE to transmit the synchronization signal at a candidate frequency location prior to the expiration of the synchronization wait duration timer.
